(19) United States
(12) Patent Application Publication
(10) Pub. No.: US 2008/0210263 A1
(43) Pub. Date: Sep. 4, 2008

(54) METHOD AND APPARATUS FOR WASHING AND RINSING GLASSWARE

(75) Inventors: Brian A. Brunswick, Tipp City, OH (US); Thomas A. Grueser, Donnelsville, OH (US)

Correspondence Address: THOMPSON HINE LLP;Intellectual Property Group, P.O Box 8801, DAYTON, OH, 45401-8801, US

(73) Assignee: Premark FEG L.L.C., Wilmington, DE (US)

(21) Appl. No.: 12/029,878

(22) Filed: Feb. 12, 2008

Related U.S. Application Data
(60) Provisional application No. 60/890,301, filed on Feb. 16, 2007.

(51) Int. Cl. B08B 3/02

(52) U.S. Cl. 134/26; 134/56 D

(57) ABSTRACT

A warewashing apparatus includes a chamber for holding items to be cleaned, a wash system including a plurality of wash nozzles for spraying wash liquid and a rinse system including a plurality of rinse nozzles for spraying rinse liquid. A controller is programmed to carry out a cleaning cycle during which: wash liquid is sprayed onto items in the chamber during a wash step; subsequent to the wash step, hot rinse liquid is sprayed onto the items during a primary rinse step; and subsequent to the primary rinse step, cool rinse liquid is sprayed onto the items during a secondary rinse step.

### CROSS-REFERENCE

This application claims the benefit of U.S. provisional application Ser. No. 60/890,301, filed Feb. 16, 2007.

### TECHNICAL FIELD

This application relates generally to warewash systems and, more particularly, to a warewash system and method for washing and rinsing glassware.

### BACKGROUND

Bars and restaurants use glass washer type dish machines to clean all types of glassware ranging from wine and martini glasses to tumblers. The glass washers can vary from carousel to batch style machines.

Commercial warewashing involves highly productive machines having fixed, short washing and rinsing cycles. End result temperatures for such machines can range from 75 degrees F. to 180 degrees F. or higher depending on whether the machine is a hot sanitizer or is a cold chemical machine. High temperature machines typically utilize a final rinse of water at a minimum temperature of 180 degrees F. The National Sanitization Foundation (NSF) has established a heat factor measured in heat unit equivalents (HUE) per second which cumulated must reach a minimum total of 3600 HUE to be considered effective in sanitizing. However, unless time is given for the glasses to cool, hot rinses may cause glassware to crack when placed in a chiller due to rapid temperature change. Low temperature machines typically rinse with water at a minimum temperature of 75 degrees, inadequate to sanitize itself, but which contains a chemical such as a chlorine sanitizer. The sanitizer is typically not rinsed off and often leaves a chlorine smell and taste on the glasses.

Water quality can also play a role in washing and rinsing glassware. Total dissolved solids (TDS) in the rinse water can leave film and spots on glasses. Typically, TDS levels above 150 ppm will result in a cloudy appearance on the glassware. Often times, the glassware is hand polished to provide a clear appearance. Depending on location, tap water frequently has levels of TDS above 200 ppm and, for example, even up to 1000 ppm in certain regions.

Referring to FIGS. 1 and 2, glass 10 and rack 12 geometry can also play a role in washing and rinsing glassware. A foot 14 (also referred to as a base or umbrella) of the glasses 10 can shield a bowl 16 of the glasses from receiving rinse water, particularly at the outside edges of the rack 12 where the rinse water approaches the glassware at its most acute angle. Additionally, the rack 12 itself tends to shield the glasses from the rinse water.

Hand polishing requires bar and restaurant owners to pay a person to manually polish glasses after the glassware has already been washed and sanitized by the dish machine. There is a need to provide a rinse system that can provide relatively cool and/or clear glassware.

### SUMMARY

In one aspect, a glassware washing method involves spraying the glassware with wash liquid during a wash step, spraying the glassware with hot rinse liquid during a primary rinse step and, subsequent to the primary rinse step spraying the glassware with reverse osmisi (RO) rinse liquid during an RO rinse step, where a temperature of the RO rinse liquid is substantially less than a temperature of the hot rinse liquid sprayed during the primary rinse step.

In another aspect, a glassware washing method involves spraying the glassware with wash liquid during a wash step, spraying the glassware with hot rinse liquid during a primary rinse step and, subsequent to the primary rinse step spraying the glassware with a cool rinse liquid during a final rinse step to bring the temperature of the glassware down to a temperature that is more suitable for glassware handling and/or that will not adversely affect the temperature of liquids placed in such glassware.

### BRIEF DESCRIPTION OF THE DRAWINGS

FIG. 1 shows a glass;

FIG. 2 shows a rack of glasses;

FIG. 3 shows an exemplary system including rotating wash and rinse arms;

FIGS. 4 and 5 show an exemplary system including rotating wash and rinse arms and fixed upper rinse arms; and

FIG. 6 shows an exemplary glasswasher system with a rinse system having a cool rinse portion and a hot rinse portion.

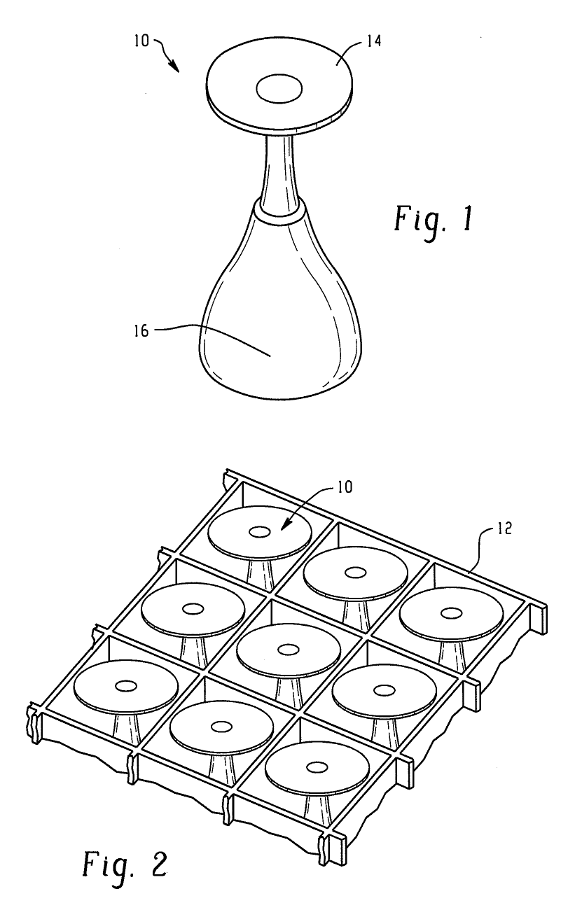

### DETAILED DESCRIPTION

It has been found that only a small amount of pure water (e.g., ⅓ gallon) may be needed to remove a TDS film and spotting from glassware. Adding a reverse osmosis (RO) misty water spritz (or other RO water delivery method) after a hot rinse cycle may remove the TDS film and spotting from the glassware to achieve a clear, visually appealing glass. Also, providing the RO misty spritz (or a tap water spritz) at a lower temperature (e.g., less than 180 degrees F., and preferably less than 90 degrees F., such as at about 70 degrees F.) after the hot rinse cycle may sufficiently cool the glasses to the point that they can be placed in a chiller with a reduced probability for breakage. The system described below may be useful in washing and rinsing many types of glassware including stemware such as champagne flutes, cocktail glasses, sherry glasses, wine glasses, snifters, etc., while sufficiently sanitizing the glasses.

A method for washing glassware includes loading the glassware into a rack and placing the rack into a glasswasher. Wash liquid is applied to the glassware (e.g., for a period of about 40 seconds or other suitable washing time) from above and below the rack of glassware as will be described in greater detail below. After the wash step is completed (including any dwell time), a primary rinse step begins and fresh hot water (e.g., at a temperature of 160 degrees F. or more, such as 180 degrees F. or more) is delivered to the glassware from above and below the rack of glassware. In some embodiments, the wash and rinse cycles produce a measurable cumulative heat factor of 3600 HUE, which is the amount of heat applied to a foodware surface during exposure to heat within a warewasher as currently defined by the NSF.

In one embodiment, after completion of the primary rinse step, a secondary, RO rinse step begins for removing TDS film and/or spots from the glassware deposited during the wash and rinse cycles that may utilize water having relatively high levels of TDS, such as 200 ppm or more. During this RO rinse step, an RO misty water spritz is sprayed onto the glassware, for example, from above and/or below the rack of glassware. In some embodiments, the RO misty water spritz may have a TDS level of not more than 30 ppm. The RO misty water spritz is delivered at a rate and in an amount sufficient to remove TDS film and/or spots from the glassware and at a temperature (e.g., less than 90 degrees F., such as at about 70 degrees F.) to cool the glassware a desired amount.

In another embodiment, after completion of the primary rinse step, a secondary, rinse step begins for during which cool rinse water (e.g., tap water) is sprayed onto the glassware, for example, from above and/or below the rack of glassware. The cool rinse water is delivered at a temperature (e.g., less than 90 degrees F., such as at about 70 degrees F.) and in a volume to cool the glassware a desired amount (e.g., to provide a resultant glassware temperature of 120 degrees F. or less, e.g, 110 degrees F. or less). However, other variations are possible.

The foregoing methods may be carried out in a variety of types of warewash machines. For example, a box-type machine such as the machine shown and described in U.S. Pat. No. 7,021,322, the specification of which is incorporated herein by reference. However, the method could also be carried out in an undercounter type machine or, in some cases a pass through conveyor type machine.

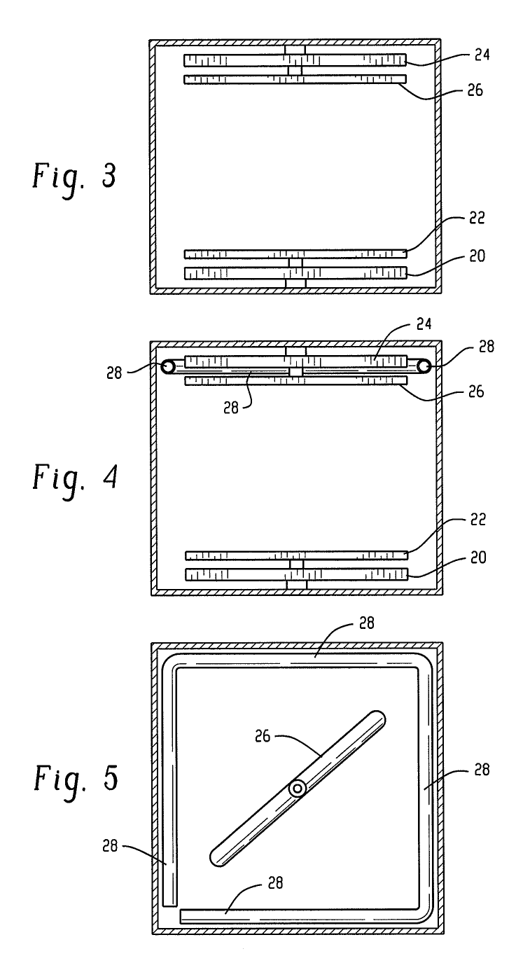

Current glasswashers typically utilize only a rotating or a fixed rinse system. A four arm rotating rinse arm does a fine job rinsing glasses in the center of the rack on the outside. Referring to the schematic front elevation of FIG. 3, a typical box machine using only rotating arms is shown and includes a rotating lower wash arm 20 (with associated nozzles) and a rotating lower rinse arm 22 (with associated nozzles), and a rotating upper wash arm 24 (with associated nozzles) and rotating upper rinse arm 26 (with associated nozzles). However, the geometry of the rack, wine glass, and water direction makes it difficult to achieve a perfect glass with an RO rinse when using only a rotating rinse arm. Accordingly, for the purpose of carrying out the above noted methods in a box-type machine, a hybrid style rinse system may be used to achieve improved results. Referring to the schematic front elevation of FIG. 4 and top plan of FIG. 5, a rotating lower wash arm 20 and a rotating lower rinse arm 22 are provided and a rotating upper wash arm 24, rotating upper rinse arm 26, and one or more fixed rinse arm lengths 28 are provided. In the illustrated embodiment the fixed arm extends around the periphery of the top of the wash chamber (e.g., four fixed arm lengths are provided, one on each side of the machine), and the fixed arm includes fine misting nozzles (e.g., nozzles having an orifice size of about 0.3″ with a ‘V’ shaped fan). The four fixed arm lengths may be interconnected and fed by a single inlet opening, or the fixed arm lengths can be separated into two or more discreet units with a corresponding number of inlet openings. However, other embodiments may include less than four fixed rinse arm lengths (e.g., two fixed rinse arms on opposite sides of the machine).

In one embodiment, clean hot water is delivered through each of rinse arms 22, 26 and 28 during the primary rinse step. During the RO rinse step, cooler RO water is delivered through each of the rinse arms 22, 26 and 28 to obtain full coverage of the glasses, rinsing of any TDS residuals and also cleaning the glasses. Where RO water is not used, during a cool water rinse step cool tap water is delivered through each of the rinse arms 22, 26 and 28.

In another embodiment, during the primary rinse step hot rinse water delivery to the fixed rinse arm 28 may be closed off (e.g, as by a valve), and then during the RO rinse (or cool tap water rinse) the valve may be opened to deliver the cool RO water (or cool tap water) through each of the rinse arms 22, 26 and 28. By using both the rotating upper rinse arm and the fixed upper rinse arm, the rotating upper rinse arm rinses the glasses on the inside of the rack while the fixed upper rinse arms/system rinses the glasses around the outside of the rack. The lower rotating rinse arm typically does a fine job rinsing the inside of the wine glasses as long as the hole spacing for the rinse water allows water to reach the inside of each glass. A four tube rinse arm does a better job delivering water to all the insides of the wine glasses.

Other variations are possible. For example, the cool water (RO or clean tap) may be delivered in one or more stages, using a first spray, followed by a pause, and then a second spray. In one implementation the first spray may be done through rotating rinse arms 22 and 26 only, and the second spray may be done through the fixed rinse arms 28 only. However, each of the two or more cool water sprays could also be delivered (i) through all rinse arms (rotating and fixed), (ii) through only the rotating rinse arms or (iii) through only the fixed rinse arms.

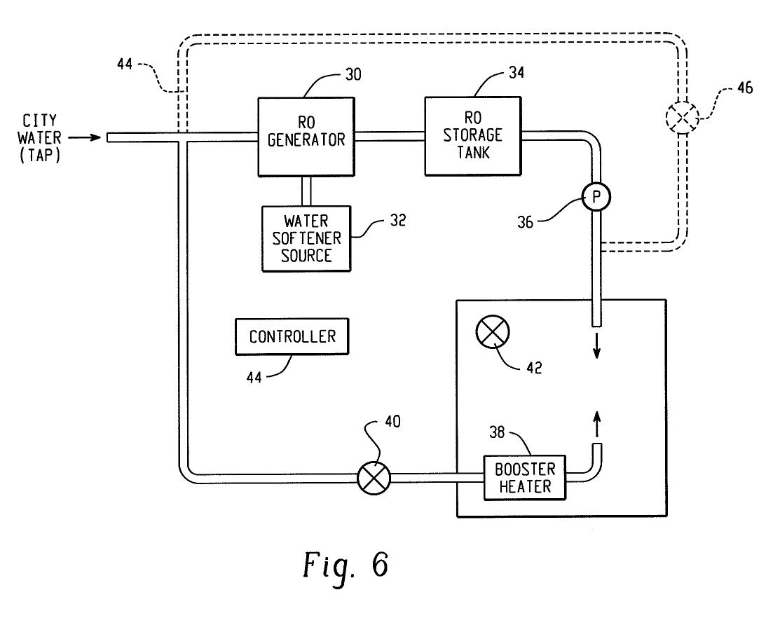

Referring to FIG. 6, a schematic depiction of a glasswasher system including an RO system for providing RO water for the glasswasher is shown, and includes an RO unit 30, a source 32 of water softener and a RO water storage tank 34. On site water passes through the RO unit 30 and the output RO treated water is delivered to the storage tank 34 so as to be available on an as needed basis for the RO rinse. The storage tank 34 may be connected to a pump 36 that that feeds the rinse system of the warewasher. During primary rinsing the pump 36 is off and heated water (e.g., as from a booster heater 38) is delivered to the rinse system under line pressure (e.g., as by opening a valve 40 that permits water flow into the booster). During the RO rinse the pump 36 is operated and the booster valve 40 is closed so that only RO water is delivered to the rinse system. Backflow prevention may be included to prevent cool RO water from flowing back into the booster during the cool RO rinse step. Also, one or more valves 42 may be provided in the rinse system lines to enable selective delivery of the hot rinse water and cool RO rinse water to desired rotating and/or fixed rinse arms. A controller 44 is shown for operating the valves, pumps and other machine components. The controller includes memory in which one or more washing sequences are stored, which sequences may be selected by a user utilizing a machine interface.

An alternative embodiment of a machine that does not use RO water is represented by cool water rinse line 44 and associated valve 46 shown in dashed line form. In this embodiment, the RO generator 30, storage tank 34 and pump 36 may be absent, and the line pressure is used to feed a secondary, cool tap water rinse by simply opening the valve 46. An RO selective embodiment may be provided with both the RO system and the cool water rinse line 44, with the user able to select between a cycle that includes a secondary cool RO rinse and a cycle that provides a secondary cool tap water rinse.

In one example, the amount or RO rinse water used during the secondary, cool RO rinse may be about 50% or less (e.g., 40% or less) of the amount of hot water used during the primary rinse step. Similarly, the amount of cool tap water used during the secondary, cool tap rinse may be about 50% or less (e.g., 40% or less) of the amount of hot water used during the primary rinse step. However, variations are possible, including percentages higher than 50%, particularly where the process is intended to bring the glass temperature down to lower temperatures (e.g., less than 100 degrees F.).

It is to be clearly understood that the above description is intended by way of illustration and example only and is not intended to be taken by way of limitation, and that changes and modifications are possible.

What is claimed is:

1. A method of cleaning glassware, the method comprising the steps of:
placing the glassware in a glasswasher, and within the glasswasher:
spraying wash liquid onto the glassware during a wash step;
subsequent to the wash step, spraying hot rinse liquid onto the glassware during a primary rinse step; and
subsequent to the primary rinse step, spraying cool rinse liquid onto the glassware during a secondary rinse step.

2. The method of claim 1 wherein:
the hot rinse liquid is heated tap water; and
the cool rinse liquid is RO water.

3. The method of claim 2 wherein:
the hot rinse liquid is at least 160 degrees F.; and
the cool rinse liquid is less than 90 degrees F.

4. The method of claim 3 wherein:
the hot rinse liquid is delivered through rotating rinse arms of the glasswasher; and
the cool rinse liquid is delivered through rotating rinse arms of the glasswasher.

5. The method of claim 4 wherein:
the hot rinse liquid is delivered only through rotating rinse arms; and
the cool rinse liquid is delivered through rotating rinse arms and at least one fixed rinse arm.

6. The method of claim 5 wherein the cool rinse liquid is delivered in at least two stages.

7. The method of claim 6 wherein during a first stage the cool rinse liquid is delivered through rotating rinse arms only and during a second stage the cool rinse liquid is delivered through at least one fixed rinse arm and not through any rotating rinse arm.

8. The method of claim 4 wherein:
the hot rinse liquid is delivered through both rotating rinse arms and at least one fixed rinse arm; and
the cool rinse liquid is delivered through both rotating rinse arms and at least one fixed rinse arm.

9. The method of claim 3 wherein:
the hot rinse liquid is delivered through rotating rinse arms of the glasswasher; and
the cool rinse liquid is delivered through at least one fixed rinse arm of the glasswasher and not through any rotating rinse arm of the glasswasher.

10. The method or claim 3 wherein:
a volume of cool rinse liquid delivered during the secondary rinse step is less than 50% of a volume of hot rinse liquid delivered during the primary rinse step.

11. The method of claim 1 wherein:
the cool rinse liquid is tap water;
the hot rinse liquid is at least 160 degrees F.;
the cool rinse liquid is less than 90 degrees F.; and
a volume of cool rinse liquid delivered during the secondary rinse step is less than 50% of a volume of hot rinse liquid delivered during the primary rinse step.

12. The method of claim 11 wherein:
during the primary rinse step the hot rinse liquid is delivered through rotating rinse arms; and
during the secondary rinse step the cool rinse liquid is delivered through one or more fixed rinse arms.

13. The method of claim 12 wherein:
during the secondary rinse step the cool rinse liquid is delivered through both rotating rinse arms and one or more fixed rinse arms.

14. The method of claim 13 wherein:
during the primary rinse step the hot rinse liquid is delivered through both rotating rinse arms and one or more fixed rinse arms.

15. A warewashing apparatus, comprising:
a chamber for holding items to be cleaned,
a wash system including a plurality of wash nozzles for spraying wash liquid;
a rinse system including a plurality of rinse nozzles for spraying rinse liquid;
a controller programmed to carry out a cleaning cycle during which:
wash liquid is sprayed onto items in the chamber during a wash step;
subsequent to the wash step, hot rinse liquid is sprayed onto the items during a primary rinse step; and
subsequent to the primary rinse step, cool rinse liquid is sprayed onto the items during a secondary rinse step.

16. The apparatus of claim 15 wherein:
the rinse system includes a hot rinse portion that delivers hot rinse liquid that is at least 160 degrees F. during the primary rinse step; and
the rinse system includes a cool rinse portion that delivers cool rinse liquid that is less than 90 degrees F. during the secondary rinse step.

17. The method of claim 16 wherein:
the control operates such that a volume of cool rinse liquid delivered during the secondary rinse step is less than 50% of a volume of hot rinse liquid delivered during the primary rinse step.

18. The method of claim 17 wherein:
the rinse system includes an RO water production unit and during the secondary rinse step the cool rinse liquid is cool RO water.

19. The method of claim 15 wherein:
the rinse system includes a lower rotating rinse arm, an upper rotating rinse arm and at least one upper fixed rinse arm; and
during the secondary rinse step, cool rinse liquid is delivered through nozzles of the upper fixed rinse arm.
